(19) United States
(12) Patent Application Publication
(10) Pub. No.: US 2008/0135587 A1
(43) Pub. Date: Jun. 12, 2008

(54) Time-Pressure System For Dosing Liquids

(75) Inventor: Giuseppe MONTI, Pianoro (Bologna) (IT)

Correspondence Address: WILLIAM J. SAPONE;COLEMAN SUDOL SAPONE P.C., 714 COLORADO AVENUE, BRIDGE PORT, CT, 06605, US

(73) Assignee: MARCHESINI GROUP S.P.A., Pianoro (Bologna) (IT)

(21) Appl. No.: 11/944,647

(22) Filed: Nov. 26, 2007

(30) Foreign Application Priority Data
Dec. 6, 2006 (IT) BO2006A 000836

(51) Int. Cl. B67D 5/08; B65D 37/00; B65D 88/54

(52) U.S. Cl. 222/638; 222/214; 222/333

(57) ABSTRACT

A time-pressure system for dosing liquid, comprising: a tank of liquids which communicates with at least one discharge conduit; organs for regulating the pressure of the liquids at a predetermined level; a choke unit, acting on a section of the discharge conduit in order to obstruct/allow passage of the pressurised liquids coming from the tank, thus determining projection of dosed quantities of liquids externally at predetermined time intervals. In particular, the choke unit comprises a brushless motor, which cyclically moves an obstructing element between a choked position and a disengaged position of the section.

### BACKGROUND OF THE INVENTION

The invention concerns the technological sector of time-pressure dosing systems.

Time-pressure dosing systems are known which comprise: a tank for containing a liquid or mixture of liquids, communicating with one or more conduits (for example made of a silicone material) which discharge the liquids into relative containers; organs for regulating the pressure of the liquids contained inside the tank at a predetermined level; a choke unit for a section of the discharge conduit, activated to block/allow passage, at predetermined time intervals, of pressurised liquids coming from the tank, consequently defining and projecting dosed quantities of liquids into containers positioned below the discharge conduit; an auxiliary device, situated between the nozzle of the discharge conduit and the choke unit, also acting by mechanical interference on a corresponding section of the discharge conduit to prevent dripping of liquid after projection of the dosed quantities into the containers; and an electronic control unit which manages the functioning of the pressure regulating organs, the choke unit and the auxiliary device.

The choke unit substantially comprises an element which obstructs a section of the discharge conduit and an actuator organ which moves the obstructing element between a choked position and a disengaged position of the section of conduit, respectively to obstruct and to allow the passage of pressurised liquids contained in the tank. The liquids are consequently projected in dosed quantities along the discharge conduit into the corresponding container elements. It is known that the quantity of liquids defining a relative dose is determined by the time interval which elapses between the disengaging and subsequent choke of the section of discharge conduit by the obstructing element, also taking into consideration the pressure to which the liquids inside the tank are subjected and the geometric dimensions of the discharge conduit.

At present, the choke units prevalently consist of pneumatic or electromagnetic valves, the relative obstructing element thereof being activated by a pneumatic or electromagnetic actuator, in ON-OFF mode. This type of valve has intrinsic limitations, since it is impossible to ascertain or control the motion law according to which it operates: the time intervals elapsing between the opening and closing commands to the valves issued by the control unit and the freeing and choke of the section of discharge conduit have to be ascertained by experiment and will in any case vary over time, for example because of aging of the materials and wear of components.

The abovementioned drawbacks, typical of choke units of known type, are even more of a disqualification when time-pressure dosing systems are designed for specific applications, for example, the pharmaceuticals and cosmetics sectors, where it is extremely important to dispense predetermined dosed quantities which are exactly similar to one other. The opening time of the valve is in practice subject to a degree of uncertainty which is unsuitable for such applications, since the two transitory stages, in which respectively the disengaging and the choke of the section of discharge conduit take place, cannot be controllable or predictable over time.

This becomes even more evident when high productivity is required: in this case the pressure of the liquids contained in the tank will be higher and the time of opening of the valve, during which the passage of the liquids takes place, consequently defining a relative dosed quantity, will be even shorter.

A further drawback with valves of known type (for example pneumatic or electromagnetic) is that it is difficult to adjust the action of occluding the discharge conduit to take into account the type of liquid running through it. This is because the choke action on the discharge conduit must vary according to the viscosity of the various liquids—a need that cannot be satisfied by this type of valve.

### SUMMARY OF THE INVENTION

In light of the above, the aim of the invention is to provide a time-pressure system for dosing liquids which satisfactorily obviates the above-described drawbacks. In addition, it is desirable to attain a choke unit which also satisfies required standards of reliability, precision, productivity and operating regularity even for specific applications such as those relating to the pharmaceuticals and the cosmetics sectors.

A further aim of the invention consists of realising a system having relatively low costs when taken in the context of the advantages provided.

The above aims are obtained, in accordance with the content of the claims, by a time-pressure system for dosing liquids comprising: a tank for containing liquids communicating with at least a discharge conduit for the liquids; organs for regulating a pressure of the liquids contained inside the tank at a predetermined level, a choke unit acting on a section of the discharge conduit, for obstructing/allowing passage of the pressurised liquid coming from the tank, in order to determine a projection of dosed quantities of the liquids out of the discharge conduit at predetermined time intervals, characterised in that the choke unit comprises an electric motor which: regulates an angular positioning of a shaft thereof according to a predetermined time law imposed by a corresponding control unit; and cyclically moves an obstructing element between a choked position of the section of the discharge conduit, in which the discharge conduit is occluded, and a disengaged position of the section, determining projection of dosed quantities of the liquids out of the discharge conduit at predetermined time intervals.

### BRIEF DESCRIPTION OF THE DRAWINGS

Any characteristics of the invention which do not emerge from the above will be more fully illustrated below, in accordance with the claims and with the aid of the appended figures of the drawings, in which:

FIG. 1 is a schematic front view of the time-pressure dosing system which is the object of the invention;

FIGS. 2A, 2B schematically illustrate details A, B, in enlarged scale, of the system of FIG. 1, during a first operational configuration;

FIGS. 3A, 3B schematically illustrate corresponding details A, B, in enlarged scale, of the system of FIG. 1, during a second operational configuration;

FIG. 4 is a front view of an embodiment of the time-pressure dosing system of FIG. 1;

FIG. 5 is a view along section V-V of the FIG. 4.

### DESCRIPTION OF THE PREFERRED EMBODIMENTS

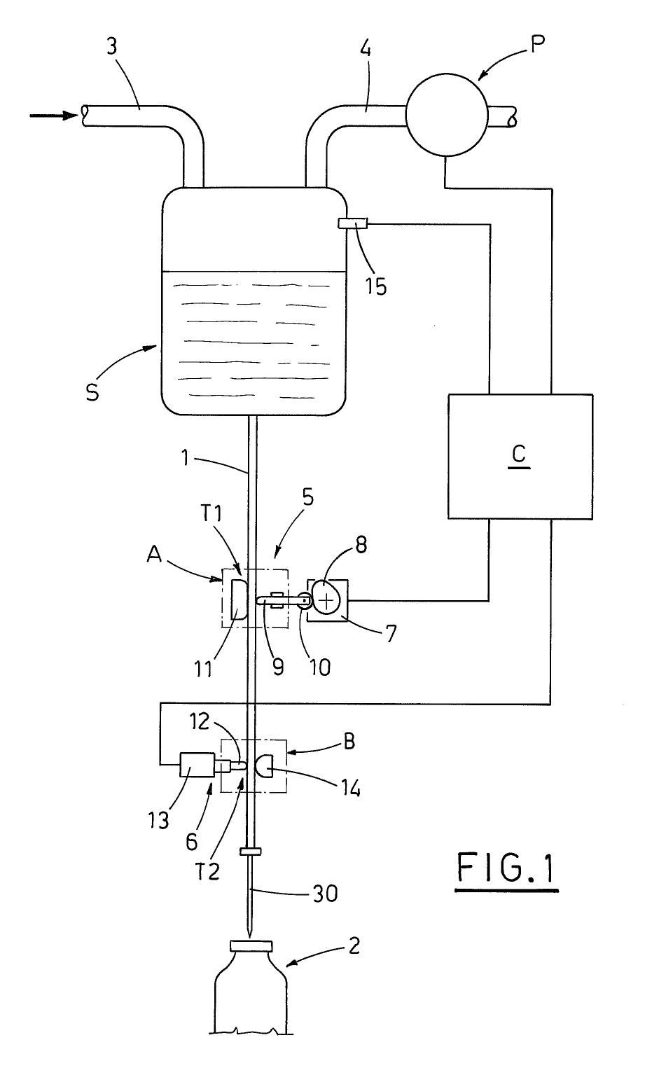

With particular reference to FIG. 1, S shows a closed tank of known type for containing pressurised liquids, which inferiorly communicates with one or more conduits 1 for discharge of the liquids into container elements 2 situated below, such as vials, tubes, sachets or the like, for example conveyed by a relative conveyor line, not shown since it is not part of the invention; the tank S is also superiorly in communication with a supply conduit of the liquids 3 and with a source of inert gas capable of generating a pressure P via a relative conduit 4.

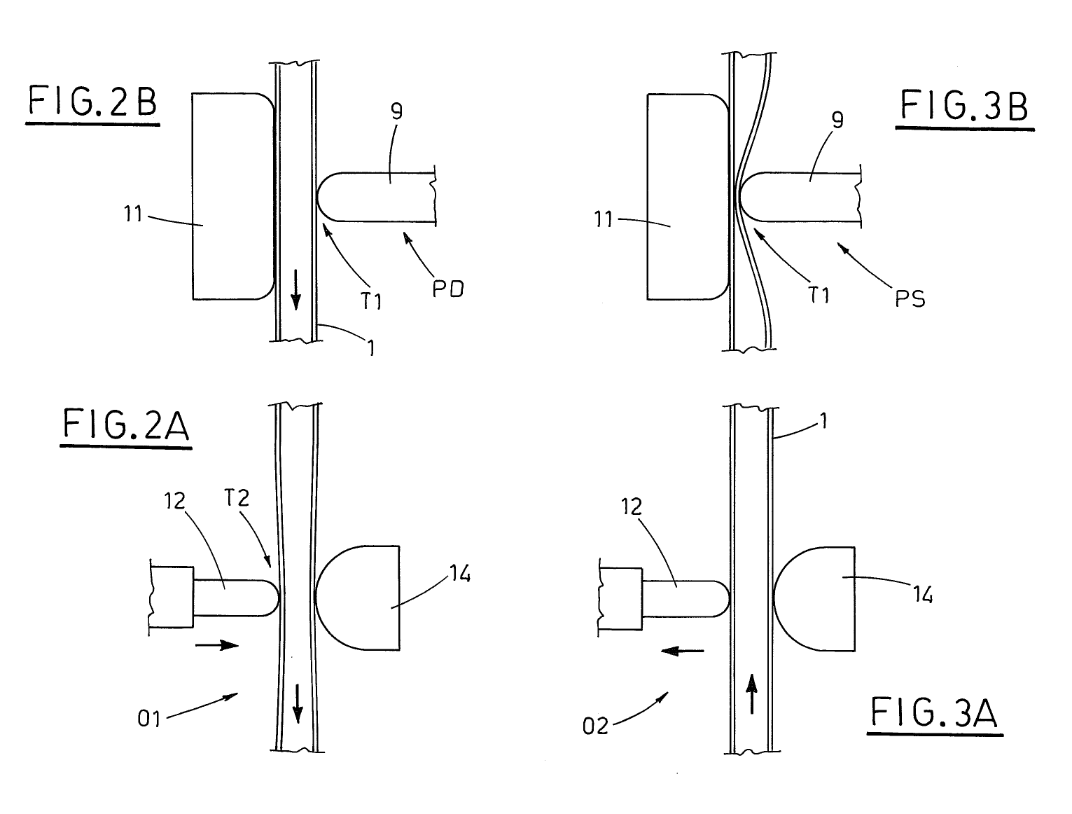

In the illustrated example, each discharge conduit 1 has an associated choke unit 5 and an associated auxiliary device 6. The choke unit 5 comprises an electric motor 7, in particular a brushless motor, for regulating an angular position of the shaft on the basis of a predetermined motion law imposed by a corresponding control unit C. The motor 7 set in rotation a cam element 8, which in turn moves an obstructing element 9 between two distinct operating positions, namely: a disengaged position PD of a corresponding section T1 of the relative discharge conduit 1, see FIG. 2B, in which the obstructing element 9 is in non-interfering contact with the conduit 1; and a choked position PS of the section T1, see FIG. 3B, in which the element 9 completely obstructs the section of the conduit T1 by elastically deforming it. In particular, an idle roller 10 is fitted superiorly to the obstructing element 9 in order to reduce friction with the cam element 8. A first abutment 11 is provided on the opposite side of the choke unit 5 with respect to the section T1 of the discharge conduit 1. The auxiliary device 6, of known type, comprises for example a stem 12 having a rounded head which stem 12 is operated by the actuator organs 13 and kept in constant contact with a corresponding section T2 of the discharge conduit 1: the stem 12, as will become clear from the following description, is activated in a phase relation with the choke unit 5 between a first configuration O1 in which it pushes against the section T2, causing a slight local elastic deformation (FIG. 2A), and a second retracted configuration O2 (FIG. 3A), in which it is in non-interfering contact with the section T2 of the discharge conduit 1; in any case, the positions assumed by the stem 12 in these two configurations O1, O2 can be varied to modify the aspirating action inside the discharge conduit 1. Also in this case, a second abutment 14 is arranged on the side of the section of conduit T2 which is opposite the side thereof where the auxiliary device 6 is situated.

In conclusion, the electronic control unit C receives an electric signal coming from a pressure sensor 15 arranged inside the tank S and regulates the functioning of the pressure source P, of the choke unit 5 and of the auxiliary device 6.

There follows a description of the functioning of the dosing system which is the object of this invention, with reference to a cycle of operation.

The electric control unit C maintains the liquids contained in the tank S at a predetermined pressure in a known way, regulating the functioning of the pressure source P on the basis of the signal received from the sensor 15. As specified above, the choke unit 5 and the auxiliary unit 6 are activated by the electronic control unit C in a suitable reciprocal phase relation. The dosed quantities of liquids are defined by the interval of opening of the section of discharge conduit 1 subjected to the action of the choke unit 5, in the case illustrated, section T1; as a result of the pressure to which the liquids inside the tank S are subjected, the dosed quantity under formation is projected along the discharge conduit 1 into a corresponding container 2 below the dosing system. In a phase relation with the formation and projection of the dosed quantity along the discharge conduit 1, the stem 12 of the auxiliary device 6 is moved to the first configuration O1 (FIG. 2A). Following exit of the dosed quantity from the relative nozzle 30 of the discharge conduit 1, the stem 12 is moved in the second configuration O2, i.e. retracted so as to create a slight depression inside the discharge conduit 1, thus preventing liquid from dripping from the nozzle 30.

The integration of the brushless motor 7 into the choke unit 5 makes it advantageously possible to accurately set and control the motion law, in which the obstructing element 9 is moved by the cam element 8 between the disengaged position PD and the choked position PS, and vice-versa; the obstructing element 9 can move only in elementary discrete steps, so that its position is always known and certain, step by step.

In other words, functional connection of the brushless motor 7 to the control unit C enables the control unit C to ascertain the exact time elapsing between the commands to open and close section T1 and, respectively, the actual passage of the obstructing element 9 into the disengaged position PD and into the choked position PS. Thus the control unit C can calculate the interval of opening of the section T1 which defines the dosed quantity with extreme accuracy, given a predetermined value for the pressure of the liquids inside the tank S; in this way all the drawbacks typical of solutions of known type are completely obviated. The choke unit 5 guarantees all the reliability, accuracy and functional regularity (generation of identical dosed quantities at all times) required for specific applications such as those in the pharmaceutical or cosmetics sector and/or where high productivity levels are required, given that for such applications the liquids contained inside the tank S have to be under greater pressure and the opening interval of the section TV must be shorter.

Therefore this invention achieves the desired aims and optimally obviates all the drawbacks mentioned above which are typical of known solutions; as a consequence the time-pressure dosing system of the invention has relatively low costs compared with the advantages obtained.

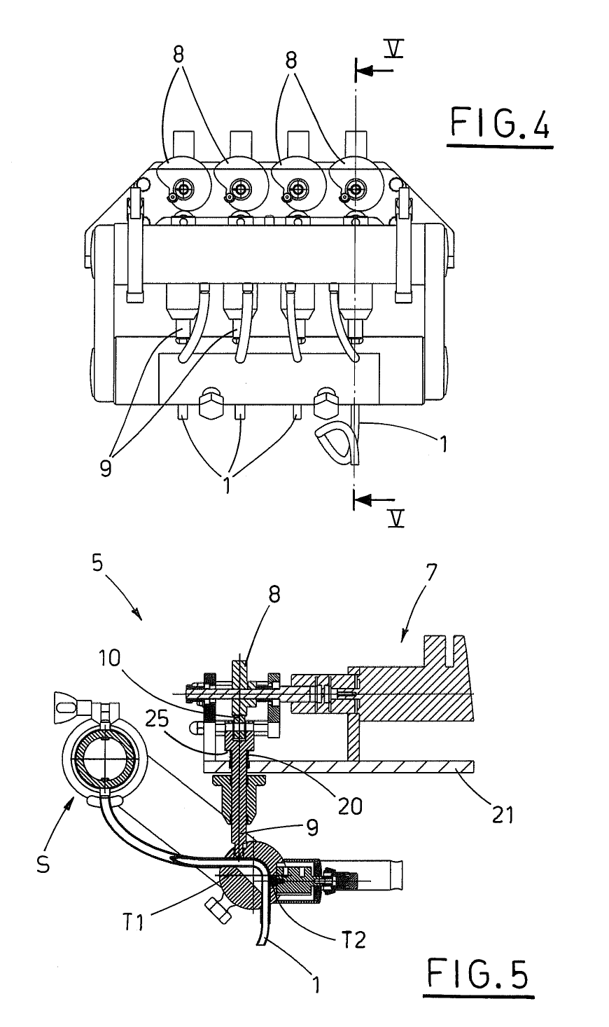

FIGS. 4, 5 show the time-pressure dosing system of the invention, according to a practical embodiment thereof. In particular, in the example shown there are elastic organs 20 positioned between the frame 21 of the choke unit 5 and a shoulder 25 afforded in the obstructing element 9, in order to maintain the obstructing element 9 in continuous contact with the cam element 8, by means of the roller 10.

The above description provides a non-limiting example, and thus any practical or applicative variants are to be considered within the ambit of protection of this invention as described above and claimed below.

What is claimed:

1. A time-pressure system for dosing liquids, comprising: a tank for containing liquids communicating with at least a discharge conduit for the liquids; organs for regulating a pressure of the liquids contained inside the tank at a predetermined level; a choke unit acting on a section of the discharge conduit, for obstructing/allowing passage of the pressurised liquid coming from the tank, in order to determine a projection of dosed quantities of the liquids out of the discharge conduit at predetermined time intervals, characterised in that the choke unit comprises an electric motor which: regulates an angular positioning of a shaft thereof according to a predetermined time law imposed by a corresponding control unit; and cyclically moves an obstructing element between a choked position of the section of the discharge conduit, in which the discharge conduit is occluded, and a disengaged position of the section, determining projection of dosed quantities of the liquids out of the discharge conduit at predetermined time intervals.

2. The system of claim 1, characterised in that the electric motor is a brushless motor.

3. The system of claim 1, characterised in that the choke unit further comprises a cam element driven into rotation by means of the electric motor and moving the obstructing element between the choked position and the disengaged position.

4. The system of claim 2, characterised in that the choke unit further comprises elastic organs functionally interposed between the frame of the choke unit and the obstructing element in order to keep the obstructing element in contact against the cam element.
